(19) United States
(12) Patent Application Publication
(10) Pub. No.: US 2007/0034758 A1
(43) Pub. Date: Feb. 15, 2007

(54) Deck rail umbrella stand

(76) Inventor: Edward K. Bates, Alberta (CA)

Correspondence Address: PATENT LAW & VENTURE GROUP, 2424 S.E. BRISTOL, SUITE 300, NEWPORT BEACH, CA, 92660, US

(21) Appl. No.: 11/136,947

(22) Filed: May 24, 2005

(51) Int. Cl. F21V 21/00

(52) U.S. Cl. 248/218.4

(57) ABSTRACT

An umbrella support apparatus is designed to engage a fence having a railing which is supported by a plurality of fence posts. A railing jaw receiver is positioned over the fence railing and a post clamp receiver is positioned below the jaw receiver and clamped to the fence posts. A strut is engaged between the jaw receiver and the clamp receiver with the jaw receiver providing a ring adapted for passing an umbrella pole through. The umbrella pole is then engaged with the clamp receiver which provides an umbrella pole terminal end engagement fixture for restraining the umbrella pole vertically and laterally.

### BACKGROUND

### RELATED APPLICATIONS

none

1. Field of the Present Disclosure

This disclosure relates generally to umbrella stands and more particularly to an umbrella stand that is configured for being mounted onto a deck railing.

2. Description of Related Art

The following art defines the present state of this field and each disclosure is hereby incorporated herein by reference:

Kizer, U.S. Pat. No. 278,973, discloses an adjustable umbrella-support, the crank rod, spring catch, and ears or disks, in combination with the notched disk, pivoted between the disks, and provided with the socket.

Hohl, U.S. Pat. No. 1,162,608, discloses an umbrella supporting device, the combination with a socket through which the stem of the umbrella is adapted to extend the socket having a plurality of spaced projecting portions, of means for securing the stem of the umbrella in the socket, a horizontal bar connecting with the socket, means for securing the socket in adjusted position relatively to the bar, the bar having an end lying between the space projecting portions of the socket, a horizontal plate provided with a segmental slot and having the inner end of the bar mounted to swing thereon, means carried by the bar and projecting through the segmental slot whereby the bar can be secured in an adjusted position on the plate, a plurality of spaced members formed with the plate and adapted to receive a support therebetween, and means movably supported on one of the members and adapted to engage the support to hold the plate thereon.

Wright, U.S. Pat. No. 2,988,310, discloses a support for clamping an umbrella on the edge of tables of various heights, comprised of a front vertical plate, upper and lower spaced bracket members extending rearwardly therefrom, the bracket members having vertically aligned threaded openings, vertical clamping screws adjustably held within said thread openings adapted to clamp the edge of a table, a wide plate providing a horizontal bracket member having an elongated opening, extending forwardly from the front vertical plate, horizontal clamping screws extending through the ends walls of the elongated opening adapted to adjustably clamp an umbrella pole, and an adjustable ring pivotally secured to the front vertical plate adjacent to the lower end thereof adapted to receive the umbrella pole and secure the pole against accidental displacement.

Mayer, U.S. Pat. No. 3,077,613, discloses an exercise bar for hospital beds or the like comprising a hollow post member having clamping means for detachably securing the same in upright position to the end frame of a hospital bed, a bearing flange fixed at the upper end of the post member, a swivel post extending axially upwardly from the hollow post member and having a boom for extending over the surface of such bed, upper end of the hollow post member to journal the swivel post therein for swinging the boom through a horizontal arc, a bearing flange fixed on the swivel post engaged in face contact with the bearing flange on the hollow post member to transfer the load between the two post members, interengageable stops on the bearing flanges for limiting the arc of rotation of the boom, one of the bearing flanges having therein a series of openings and the other having therein an opening alignable successively with those of the series by swinging the boom, and a pin carried by one of the post members and the swivel post, the pin being normally aligned with the one opening and biased for insertion through the openings in both flanges whenever the latter are aligned.

Holzman, U.S. Pat. No. 3,559,941, discloses a mounting assembly for securing a measuring device requiring a specific orientation to a variety of structures. The device includes a pair of adjustable, spaced mounting blocks, secured to a base plate, which are adapted to conform to a variety of supporting shapes. Serrations on the hardened steel mounting blocks provide secure placement when the assembly is clamped to the supporting structure. The combination of an angled bracket including appropriately placed arcuate slots provide even greater versatility in orienting the device.

Sample, U.S. Pat. No. 3,943,524, discloses pair of U-shaped members that are affixed to each other in spaced parallel inverted position. Each of the members has a pair of spaced parallel arms joined by a head perpendicular to the arms. An antenna affixing device links the members for supporting a TV antenna in upright position. A fastening device on the members affixes the members in inverse position on a parapet.

Calabro, U.S. Pat. No. 4,500,064, discloses a support assembly for a mast that includes a mounting plate to which a cradle can be permanently fused or attached by means of spacers of different thickness to select the desired spacing of the mast from the mounting plate. The cradle has an arcuate mast support surface which extends axially to a length at least twice the arcuate length. The arcuate arc length is preferably less than 180.degree. The mounting plate is adapted to be secured to a masonry wall, such as the side of chimney, by means of masonry screws or the like. To this end the mounting plate is provided with at least two mounting holes, at least one of which is elongated to assure that both mounting holes overlie mortar spaces between bricks in the masonry wall. The supported mast is clamped to the cradle by means of a U-bolt and toothed bracket plate. In the preferred embodiment, two such assemblies are secured to the wall with their mast support surfaces in axial alignment.

DeLeary, U.S. Pat. No. 4,582,287, discloses a stand for removably interconnecting an intermediate portion of a horizontally disposed elongated member, such as a board of a patio deck, with the lower end of a vertically disposed elongated member, such as the umbrella post of an umbrella table. The stand includes a main body having first and second spaced apart flanges for removably interconnecting the main body with the intermediate portion of the horizontally disposed elongated member. The stand also includes a socket formed in the main body, the socket opening in a direction opposite the direction in which the first and second flanges extend. The socket accepts the lower end of the vertically disposed elongated member. In the preferred embodiment, the main body consists of a U-shaped stamping having a base and two flanges extending therefrom as well as a right circular cylindrical tube welded to the base portion of the U-shaped stamping.

Klingensmith et al., U.S. Pat. No. 4,595,165, discloses a mounting structure for satellite dish antennae and method and means for anchoring the structure to the roof or sidewall of a typical residential building, such as a house. The mounting structure includes a mast for supporting the dish antennae. The anchoring means includes a bar having a back portion and sides which define an open-ended channel. The sides of the bar are further provided with integral adjoining lips which extend the length of the bar. Also included in the assembly is a clamp provided with holes through which bolt means may be inserted to tighten and secure the clamp about the mounting structure's mast to the bar's lips. When so tightened, the clamp tightly engages the external surface of the mast to prevent it from torsional movement relative to the clamp.

Ramsey et al., U.S. Pat. No. 4,946,122, discloses a pair of spaced collars that are mounted at right angles on a clamp body by retaining rings which enable the collars to rotate with respect to the clamp body. Mounting posts extend through aligned holes in the collars and clamp body. Each collar can be clamped onto the inserted post while the clamp body remains free to rotate about the post and collar. The clamp body is selectively clamped onto each post.

Lowrey, U.S. Pat. No. 5,453,756, discloses an invention that includes an improved antenna mounting apparatus for mounting a conventional antenna to a mounting structure. The antenna mounting apparatus including a pair of vertically spaced apart arms having aligned holes therethrough and a base connected to and extending between the arms. A mounting device for mounting the bracket to the mounting structure is provided with two O-ring shaped insulating members each adapted to be received in a respective one of the aligned holes in the arms; antenna connection device adapted to engage the antenna and secure the antenna to one of the spaced apart arms. A cable connection device is provided for connecting an electrical cable to the apparatus. Interconnection device are adapted to engage the antenna connection device and the cable connection device such that the antenna connection device, the interconnection device and the cable connection device all form a single structural unit extended through the aligned holes of the mounting bracket arms.

Salibra, U.S. Pat. No. 5,685,517, discloses an invention that is essentially comprised of a deck furniture mounting stand which is removably attachable to a deck's boards. By loosening or tightening nuts threadingly engaging a pair of mounting rods, the stand may be removed from, or affixed to, respectively, a deck. The stand of the present invention includes a base portion having an upper surface, a lower, deck contacting surface, and a predetermined periphery defined by a continuous edge. A cylindrical, pole (umbrella pole for instance) receiving member having a bored hole formed therein for reception of the pole is positioned in centrally, upwardly extending relation to the upper surface. Further included are two apertures formed through the base on opposite sides of the pole receiving member to receive the mounting rods which secure the stand to the decking. The mounting rods are each comprised of a linear, threaded shaft portion which terminates in a first end, and an opposite second end formed in the shape of a loop having deck engaging burrs integral therewith. The burrs penetrate the deck to provide extra support to the stand. The first end extends upwardly through the aperture and includes a nut threaded thereon to prevent the rod from falling away from the base. The loop of the second end is of a thickness smaller than the width of the spacing between two adjacent deck boards, and a width greater than that of the deck's spacing.

Niemiec, U.S. Pat. No. 5,857,658, discloses a clamping bracket for clamping an object to a structure that includes a bracket having height, an opening for receiving the object, two sides, and an end, the two sides having a cutout provided therein for receiving the structure; and, an adjustable gripping member attached to the sides for adjustably protruding into the cutouts so that the object is clamped between the end and the structure and the gripping member clamps the structure to the bracket.

Petryna et al., U.S. Pat. No. 5,961,091, discloses a pole support for use on decked surfaces consisting of planks with a gap between the planks. The pole support includes a base and at least one I-shaped retainer bar for quickly and easily attaching and releasing the base from the deck surface. The base includes a tubular sleeve for supporting the pole in a predetermined orientation with respect to the base. The pole support is useful for attaching articles such as umbrella tables or plant stands to a decked surface. The advantage is a simple, inexpensively constructed pole support which is not susceptible to corrosion and may be rapidly connected to or disconnected from a decked surface without the use of tools.

Brown, U.S. Pat. No. 6,676,094, discloses a deck appurtenance that includes an item to be supported, a support pole supporting the item, and a support bracket. The support bracket includes a first end detachably coupled to a midline portion of the support pole, a second end detachably coupled to a component of a deck rail, and a body connecting the first end to the second end.

Otterman, U.S. Pat. No. 6,702,245, discloses a bracket that is adapted to attach to a deck rail and hold an umbrella with a long pole similar to the umbrellas that come in patio sets. The bracket is a piece of material with an opening at one end. Within the opening on the bottom of the piece of material, a ring is placed which is adjustable and adapted to tighten against the umbrella's pole. On the other end of the bracket on its bottom side, two L shaped brackets are placed. These two L shaped brackets are spaced a distance equal to the width of a deck rail. On both L shaped brackets, a slot is placed for a belt. The belt contains a buckle that enables the belt to be tightened. To use the bracket one places the deck rail between the two L shaped brackets and then tightens the belt against the deck rail to hold the bracket in place. Then one places the umbrella through the opening and tightens the adjustable ring against the umbrella's pole to hold the umbrella in place. For additional security, one places a small rubber mat on the deck under the umbrella pole to insure that the pole will not slip.

Our prior art search with abstracts described above teaches supports of various types including those that provide a receiver tube with clamping device, aperture with clamping, table mount, and various anchoring devices. Niemiec teaches a deck rail clamp, and several post supports are known. However, the prior art fails to teach a two-point adjustable support of the type presented herein. The present disclosure distinguishes over the prior art providing heretofore unknown advantages as described in the following summary.

### SUMMARY

This disclosure teaches certain benefits in construction and use which give rise to the objectives described below.

Patio umbrellas are normally mounted in heavy bases which sit on the patio under a patio table. Variations of this approach are well known as well. However, it is often necessary to mount the umbrella on a deck which provides little room and does not necessarily provide a table. The prior art does not provide a solution to this problem. The present umbrella mount meets this need and provides advantages as described herein. An umbrella support apparatus is designed to engage a fence, or deck which has a railing supported by a plurality of fence posts. To accomplish this, a railing jaw receiver is positioned over the fence railing and a post clamp receiver is positioned below the jaw receiver and clamped to the fence posts. A strut is engaged between the jaw receiver and the clamp receiver with the jaw receiver providing a ring adapted for passing an umbrella pole through. The umbrella pole is then engaged with the clamp receiver which provides an umbrella pole terminal end engagement fixture for restraining the umbrella pole vertically and laterally.

A primary objective inherent in the above described apparatus and method of use is to provide advantages not taught by the prior art.

Another objective is to provide a means for mounting an umbrella on a deck railing.

A further objective is to provide such means which may be moved between selected points on the deck railing as desired without modifying the railing in any way.

A still further objective is to provide such a mount capable of raising the umbrella to a desired height above the railing.

Other features and advantages of the described apparatus and method of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawings illustrate at least one of the best mode embodiments of the present apparatus and method of it use. In such drawings:

FIG. 1 is a perspective, broken and expanded view the described apparatus;

FIG. 2 is a perspective, broken view thereof;

FIG. 3 is a perspective view thereof; and

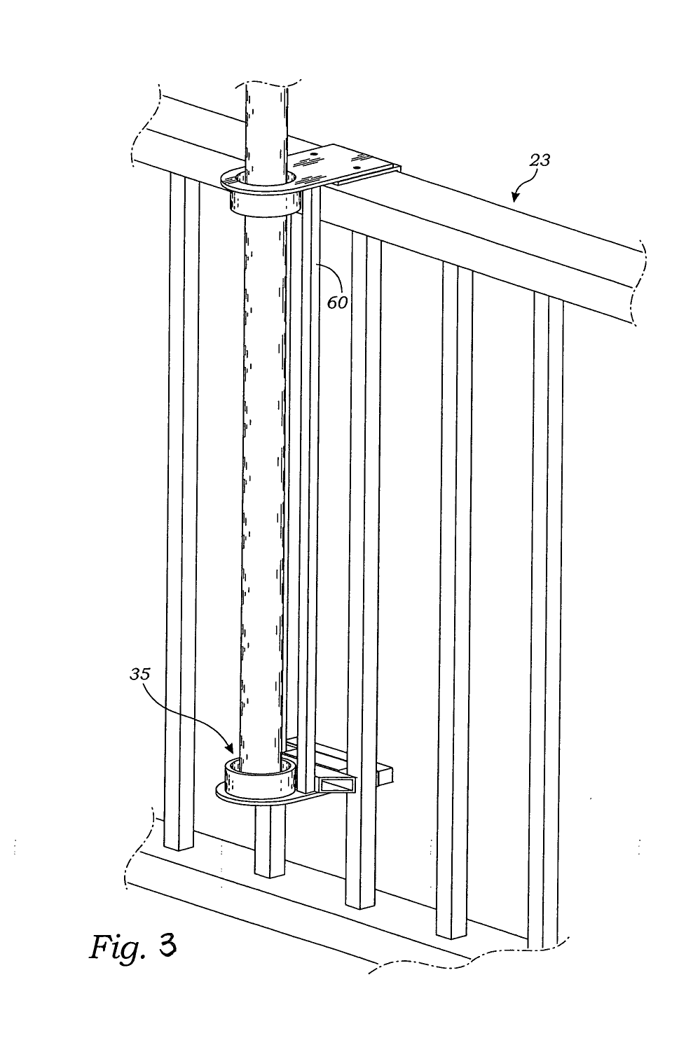

FIG. 4 is a perspective view thereof, shown as mounted to a deck railing.

### DETAILED DESCRIPTION

The above described drawing figures illustrate the described apparatus and its method of use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present apparatus and method of use.

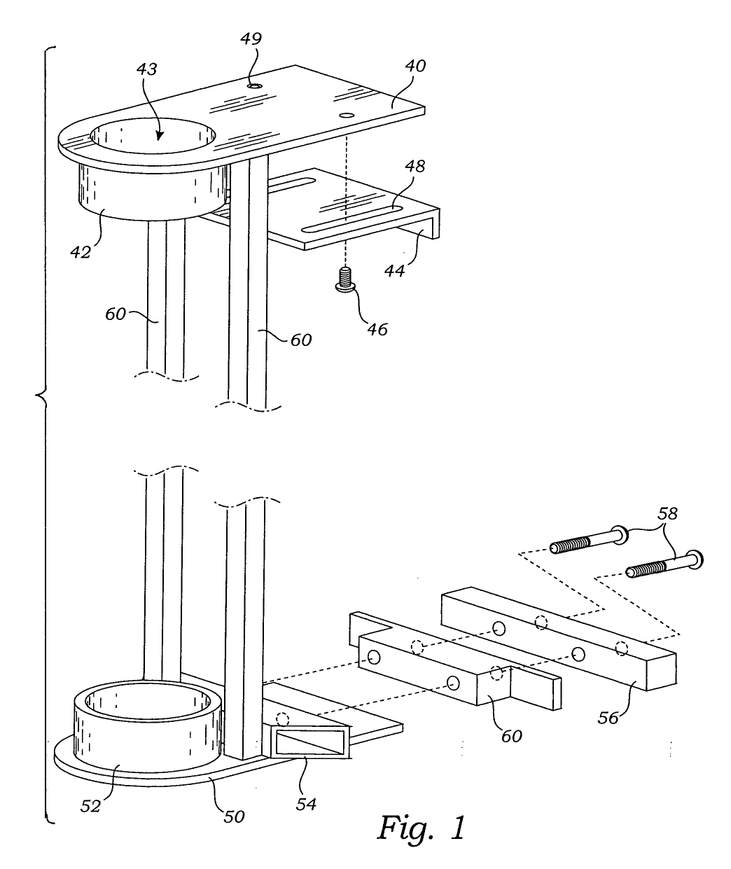

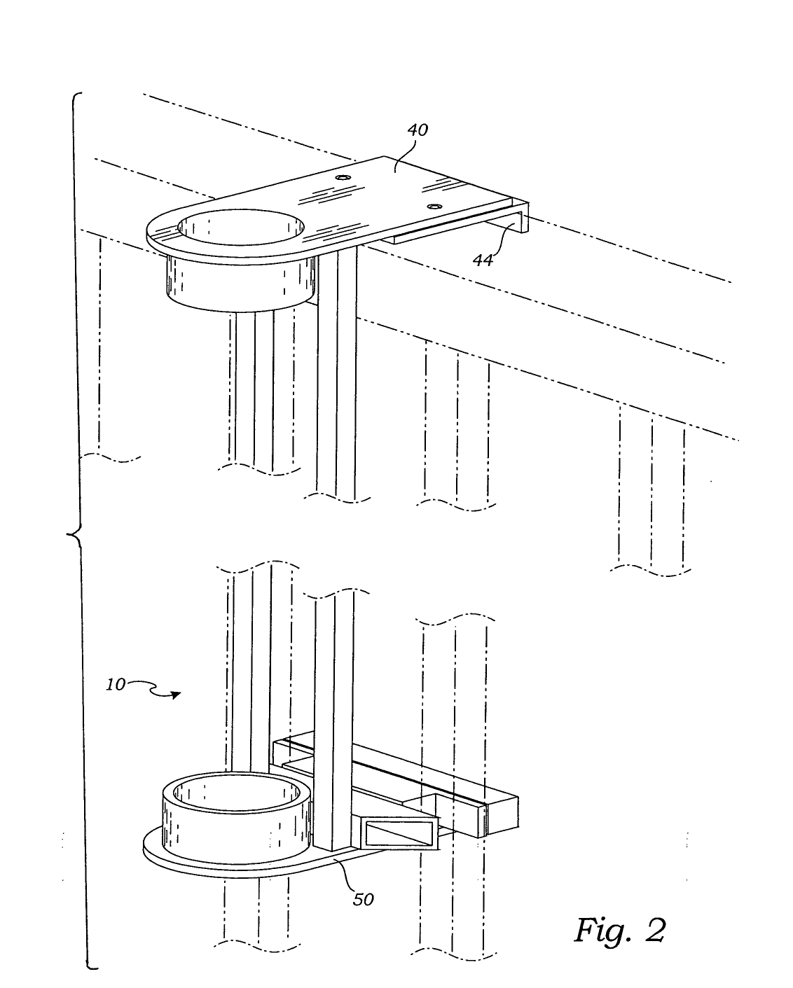

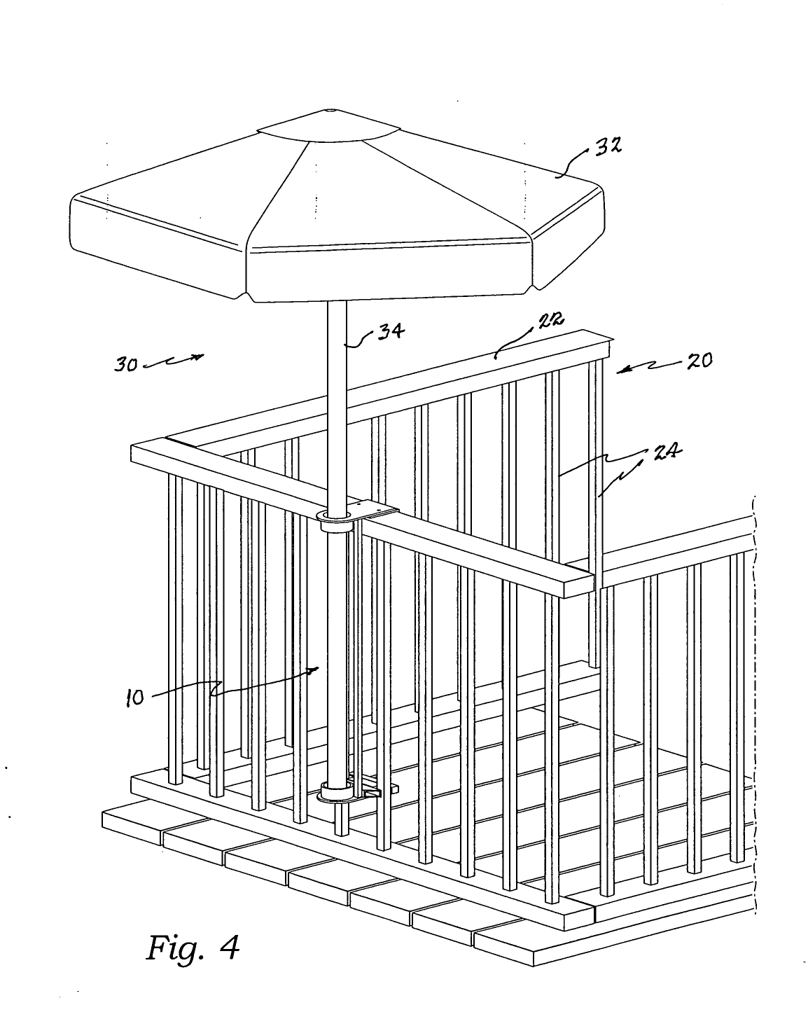

An umbrella support apparatus 10 is engaged with a fence 20 having a railing 22; typically horizontally disposed, but which may be set at an angle as well, as for on a staircase (not shown). The railing 22 is supported by a plurality of typically vertical, spaced apart, fence posts 24. See FIG. 4. An umbrella 30 has a canopy 32 and a pole 34 for supporting the canopy 32 which is mounted at an upper end 36 of the pole 34. The support apparatus 10 is a fence mounted assembly as best shown in FIG. 4. The assembly 10 provides a railing jaw receiver 40 which is positioned over the fence railing 22, and a post clamp receiver 50 which is positioned proximate the fence 20 below the jaw receiver 40 and which is clamped to the fence posts 24, as best seen in FIG. 2. A strut 60 is engaged between the jaw receiver 40 and the clamp receiver 50. Such a strut 60 may be, for instance, a single, or multiple bars, rods or tubes as shown in FIG. 1. The jaw receiver 40 provides a horizontally disposed ring 42 adapted by having an appropriately sized aperture 43, for passing the umbrella pole 34 therethrough and for thereafter restraining the umbrella pole 34 against lateral movements due to wind gusts and such. To best accomplish this, the aperture 43 is tight-fitting around the pole 34. The clamp receiver 50 provides an umbrella pole terminal-end engagement fixture 52 for restraining the umbrella pole 34, and this fixture preferably therefore receives the lower end 35 of pole 34 in tight fitting engagement to prevent the pole 34 from lifting out of the fixture 52 and for also restraining the pole 34 against lateral motion at its lower end 35.

Preferably, the jaw receiver 40 is extensible for bringing a terminal flange 44 thereof into contact with a side 23 of the fence railing 22, to secure the railing between the flange 44 and the strut 60. In one alternate embodiment, screws 46 are inserted in slots 48 and tightened in threaded holes 49 (FIG. 1).

Preferably, the clamp receiver 50 provides a fixed portion 54 and a movable portion 56 for sandwiching the posts 24 therebetween. A block or bar 60 may be attached to or a part of either the fixed portion 54 or the movable portion 56 and is preferably positionable between a pair of the posts 24 for preventing lateral motion of the apparatus relative to the fence 20. In FIG. 1 we see one embodiment wherein long screws 58 are used to mount the elements 56, 60 and 54 together as shown in FIG. 1.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. An umbrella support apparatus for engagement with a fence having a railing supported by a plurality of fence posts, the apparatus comprising: a railing jaw receiver for being positioned over the fence railing; a post clamp receiver for being positioned below the jaw receiver and clamped to the fence posts; a strut engaged between the jaw receiver and the clamp receiver; the jaw receiver providing a ring adapted for passing an umbrella pole therethrough and for thereafter restraining the umbrella pole; the clamp receiver providing an umbrella pole terminal end engagement fixture for restraining the umbrella pole.

2. The apparatus of claim 1 wherein the jaw receiver is extensible for bringing a terminal flange thereof into contact with a side of the fence railing, to secure the railing between the flange and the strut.

3. The apparatus of claim 1 wherein the clamp provides a fixed portion and a movable portion for sandwiching the posts therebetween.

4. The apparatus of claim 3 wherein one of the fixed portion and the movable portion further provides a block integral therewith, the block positionable between a pair of the posts for preventing lateral motion of the apparatus.

5. An umbrella support apparatus for engagement with a fence having a railing supported by a plurality of fence posts, the apparatus comprising: an umbrella having a canopy and a pole for supporting the canopy at an upper end thereof; and a fence mounting assembly; the mounting assembly providing: a railing jaw receiver for being positioned over the fence railing; a post clamp receiver for being positioned below the jaw receiver and clamped to the fence posts; a strut engaged between the jaw receiver and the clamp receiver; the jaw receiver providing a ring adapted for passing the umbrella pole therethrough and for thereafter restraining the umbrella pole; the clamp receiver providing an umbrella pole terminal end engagement fixture for restraining the umbrella pole.

6. The apparatus of claim 5 wherein the jaw receiver is extensible for bringing a terminal flange thereof into contact with a side of the fence railing, to secure the railing between the flange and the strut.

7. The apparatus of claim 5 wherein the clamp provides a fixed portion and a movable portion for sandwiching the posts therebetween.

8. The apparatus of claim 7 wherein one of the fixed portion and the movable portion further provides a block integral therewith, the block positionable between a pair of the posts for preventing lateral motion of the apparatus.
